(19) United States
(12) Patent Application Publication
(10) Pub. No.: US 2007/0043951 A1
(43) Pub. Date: Feb. 22, 2007

(54) Safety device for electronic devices

(76) Inventors: Thomas Grill, Villingen-Schwenningen (DE); Gerhard Rombach, Triberg (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/464,945

(22) Filed: Aug. 16, 2006

(30) Foreign Application Priority Data
Aug. 18, 2005 (DE) 10 2005 039 128.1

(51) Int. Cl. G06F 11/00; H04L 9/00; G06F 1/26; G08B 13/00; G08B 21/00; G08B 29/00

(52) U.S. Cl. 713/176; 713/181; 726/34

(57) ABSTRACT

In a safety device for electronic devices in a vehicle, it is provided that a security module with a data memory is only accessible after prior authentication; that signatures of data of the devices are stored in the data memory; and that a comparator is provided for comparing the stored data with the data respectively read out from the devices.

### PRIORITY

This application claims priority from German Patent Application No. DE 10 2005 039 128.1, which was filed on Aug. 18, 2005, and is incorporated herein by reference in its entirety.

### TECHNICAL FIELD

The invention relates to a safety device for electronic devices in a vehicle.

### BACKGROUND

Electronic devices, in particular control devices for motors or gears, often have safety-related functions, which must be protected against unauthorized access, for example before allowed changes of control characteristics, mileage readings or program codes. For detecting such illegal accesses and blocking the function of the relevant device, diagnostic queries are known, for example security access according to ISO 14229. This technology offers only a limited security, as such systems are easy to circumvent and manipulations are ultimately not traceable.

### SUMMARY

It is therefore the object of the invention to enable secure detection of manipulations. This object is achieved with the safety device according to the invention in that a security module with a data memory is only accessible after prior authentication; in that signatures of data of the devices are stored in the data memory; and in that means are provided for comparing the stored data with the data respectively read out from the devices.

### BRIEF DESCRIPTION OF THE DRAWINGS

The invention permits numerous embodiments. One of these is schematically represented in the drawing by way of several figures, and subsequently described.

FIG. 1 shows a block diagram of the safety device according to the invention,

FIG. 2 shows a flowchart to illustrate the storage of device data in the data memory and

FIG. 3 shows a flowchart to illustrate a test process.

### DETAILED DESCRIPTION

Security modules are known per se and generally contain a processor and suitable memory as well as interfaces for external communication. The access to the data memory is controlled by the processor according to security algorithms known per se. The security module is preferably executed as an integrated circuit and can be arranged in a control device, for example.

In the security module—subsequently also called a trustbox—any data at all can be stored for the devices, but it is preferably provided that the data of the devices is typical data for the devices. This could for example include version identifiers or hash files of programs used in the devices.

It can further be provided in the invention that a time stamp can be stored together with the data. This enables documentation of when a change was made, for example the integration or exchange of a device or a software version.

In some devices, data is generated or changed which is important for a subsequent diagnosis. Such data is the mileage, for example, or characteristics that are optimized either automatically or during maintenance work. It is therefore provided in a development that data which is present in the devices and changeable per se can further be stored in the data memory. Thus for example during maintenance the current mileage can be stored, and can be read out during a later access to the security module and checked for plausibility.

In an advantageous design it is provided that the security module has an interface to a computer. With the computer, the necessary data for authentication can be created and transferred to the security module, and the signatures stored there can be read out and compared with signatures of the devices present in each case. In particular, for various authorizations it is advantageous if the security module further has an interface for a smart card. Each authorized user can then authenticate himself with his smart card.

Another advantageous design consists in the fact that the security module can be connected to the devices via a bus system. It is then possible that when the security module is accessed, for example in the aforementioned computer, there can be a communication with the devices at the same time. Means for signing data that is queried by the devices can then be provided in particular in the security module. No program for data signing is needed here in the computer to be connected. The creation of the signatures of the “original devices”, which are then stored in the security module, and the creation of the signatures for the devices to be compared, occur automatically with identical algorithms.

In practical operation, for example in workshops or technical monitoring facilities, it can be necessary for otherwise unauthorized persons to read out data. It is therefore provided in a development of the invention that a restricted function of the security module is also possible without authentication.

One way of granting different access rights is for various authentication features to be provided for various devices.

The security module's capability for checking authorizations can be used, in addition to device monitoring, for further purposes, in that further functions are implemented in the security module which require a high degree of data protection. In this development, it can be provided for example that the further functions include a check of encrypted vehicle access signals and/or that the further functions include an engine immobilizer.

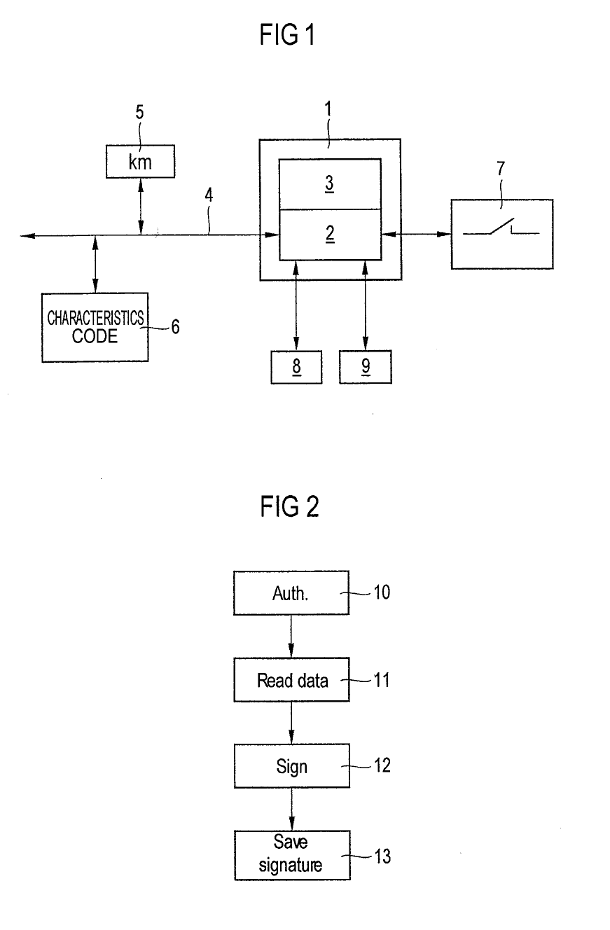

The device shown in FIG. 1 has a trustbox 1 with an actual safety area, which contains a processor 2 and, as well as other memories (not shown) for programs and constants, a data memory 3. The trustbox 1 is connected via a bus system 4 to various devices in the vehicle, of which devices only an odometer 5 and a motor management device 6 are shown. As typical data, characteristics and a program code are stored in the motor management device 6. According to a development of the invention, the trustbox 1 is also connected to a keyless entry system 7, the trustbox 1 having the task of checking and optionally releasing authentication data received from a mobile data carrier.

The trustbox 1 further has an interface 8 for connection to a computer and an interface 9 for connection to a smart card, for example by means of a plug-in connection or smart card plug-in unit.

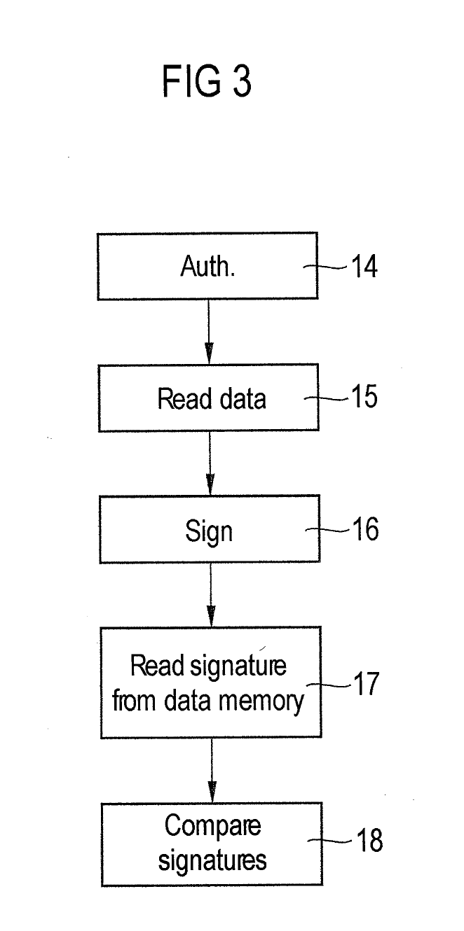

FIG. 2 shows the sequence for the integration of new devices or exchange of devices. After an authentication in 10 the data is read out from the respective device in 11, and signed in 12. In 13, the signature is then saved in the data memory 3 (FIG. 1). At a later check according to FIG. 3, after an authentication in 14, the data is read out from the devices and used to form signatures in 16. These are compared in 18 with data read out from the data memory 3 (FIG. 1) in 17. The result can be indicated and documented in an appropriate way.

What is claimed is:

1. A safety device for electronic devices in a vehicle, wherein a security module with a data memory is only accessible after prior authentication, signatures of data of the devices are stored in the data memory and means are provided for comparing the stored data with the data respectively read out from the devices.

2. A safety device according to claim 1, wherein the data of the devices is typical data for the devices.

3. A safety device according to claim 2, wherein the data includes version identifiers or hash files of programs used in the devices.

4. A safety device according to claim 1, wherein a time stamp can be stored together with the data.

5. A safety device according to claim 1, wherein data which is present in the devices and changeable per se can further be stored in the data memory.

6. A safety device according to claim 1, wherein the security module has an interface to a computer.

7. A safety device according to claim 6, wherein the security module further has an interface for a smart card.

8. A safety device according to claim 1, wherein the security module can be connected to the devices via a bus system.

9. A safety device according to claim 8, wherein means for signing data that is queried by the devices are provided in the security module.

10. A safety device according to claim 1, wherein a restricted function of the security module is also possible without authentication.

11. A safety device according to claim 1, wherein various authentication features are provided for various devices.

12. A safety device according to claim 1, wherein further functions are implemented in the security module which require a high degree of data protection.

13. A safety device according to claim 12, wherein the further functions include a check of encrypted vehicle access signals.

14. A safety device according to claim 12, wherein the further functions include an engine immobilizer.

15. A safety device for electronic devices in a vehicle, comprising a security module comprising a data memory, wherein the data memory is operable to be only accessible after prior authentication, wherein signatures of data of the devices are stored in the data memory, and a comparator for comparing the stored data with the data respectively read out from the devices.

16. A safety device according to claim 15, wherein the data includes version identifiers or hash files of programs used in the devices.

17. A safety device according to claim 15, wherein various authentication features are provided for various devices.

18. A safety device according to claim 12, wherein a further function of the safety device includes an engine immobilizer.

19. A safety device for electronic devices in a vehicle, comprising a security module comprising a data memory, wherein the data memory is operable to be only accessible after prior authentication, wherein signatures of data of the devices are stored in the data memory, and a comparator for comparing the stored data with the data respectively read out from the devices, wherein the data includes version identifiers or hash files of programs used in the devices.

20. A safety device according to claim 19, wherein the security module has an interface to a computer, and wherein the security module further has an interface for a smart card.
